(19) United States
(12) Patent Application Publication
(10) Pub. No.: US 2021/0174412 A1
(43) Pub. Date: Jun. 10, 2021

(54) AIR eCommerce

(71) Applicant: Anuthep Benja-Athon, New York, NY (US)

(72) Inventor: Anuthep Benja-Athon, New York, NY (US)

(73) Assignee: Anuthep Benja-Athon, New York, NY (US)

(21) Appl. No.: 17/180,812

(22) Filed: Feb. 21, 2021

(51) Int. Cl. G06Q 30/06

(52) U.S. Cl. CPC G06Q 30/0601

(57) ABSTRACT

Abiotic intelligence-rendered e-Commerce for rendering interactive graphics and visual illustrations for tracking and detailing geographic locations, distributions, incidences and prevalences of processor units-rendered lattices of collations of chain digital bytes attached assigned identification codes and Internet Protocol addresses in and among viewing screens and touchscreens of communication devices.

This application is a continuation-in-part of application Ser. Nos. 15/881,805 entitled Abiotic Intelligent-Rendered Pay filed Apr. 24, 2017 and 15/495,164 entitled Abiotic Intelligent-Rendered Oracle filed Apr. 24, 2017.

### FIELD OF THE INVENTION

AIR eCommerce of optimal sources-targets data, products and services.

### BACKGROUND OF THE INVENTION

The status quo e-Commerce and bricks-and-mortar logistics and distributions of information, data, products, goods, and services and related time being provided by all enterprises, institutions, governments and businesses are massively fragmented and inefficient, Consequently, immense adverse socioeconomic, human and historic consequences afflict all billions of people.

An example, in Corvid-19 pandemic, billions of people and nations have countless fragmented and inaccurate information, data, messages and accesses to goods and services, such as, but not limited to, epidemiology, clinical data on vaccines and vaccination logistics and numerous products, goods and services in almost all industries.

Another example, the status quo business model of all large multi-$billions and small eCommerce and financials services corporations is the rudimentary waits for potential customers to search, find, inquire and buy their products, goods and services.

In contradistinction, briefly, AIR eCommerce heretofore rendering freely and independently networked smartphones, laptops and desktps for freely and independently rendering adaptable SIM-protected digital lattices of collations of chain ipMAC henceforth collectively known as protected digital lattices in the relational databases, said networked smartphones, laptops and desktops being ASD, ASD pushed-RFD and RFD pushed-RFD for rendering, selecting, collatingand pushing ASD, ASD pushed-RFD and RFD pushed-RFD processor units-rendered, -selected and -collated ipMAC, according to MAC in ipMAC in and among said protected digital lattices, in and among myriad of interactive visual displays and illustrationsfor tracking and detailing geographic locations, distributions, incidences and prevalences of said processor units-rendered, -selected and -collated ipMAC for accurately, precisely and seamlessly transacting and transitingsaid protected digital lattices in and among billions of freely and independently networked smartphones, laptops and desktops.

### SUMMARY OF THE INVENTION

Abiotic intelligence-rendered eCommerce known herein as AIR eCommerce comprise ASD, ASD pushed-RFD and RFD pushed-RFD for rendering interactive graphics and visual illustrations of adaptable SIM-protected digital lattices of collations of chain ipMAC for precisely and accurately tracking and detailing geographic locations, distributions, incidences and prevalences of digital streams and pushes of said processor units-rendered, -selected and -collated ipMAC based on assigned identification codes IP addresses in and among ipMAC, in and among viewing screens and touchscreens of ASD, ASD pushed-RFD and RFD pushed-RFD.

### DESCRIPTION OF THE PREFERRED EMBODIMENTS

AIR eCommerce comprise adaptable SIM-protected digital lattices of collations of chain ipMAC for networking ASD, ASD pushed-RFD and RFD pushed-RFD for rendering and pushing ASD, ASD pushed-RFD and RFD pushed-RFD processor units-rendered, -selected and -collated ipMAC for rendering said adaptable SIM-protected digital lattices of collations of chain ipMAC henceforth collectively known as protected digital lattices in the relational databases in memories and in ASD, ASD pushed-RFD and RFD pushed-RFD processor units-rendered visual displays and illustrations comprise interactive graphics and visual presentations for tracking and detailing geographic locations, distributions, incidences and prevalences of said processor units-rendered, -selected and -collated ipMAC in and among said protected digital lattices in and among ASD, ASD pushed-RFD and RFD pushed-RFD processor units-rendered interactive visual displays and illustrations comprise said protected digital lattices in and among viewing screens and touchscreens of and among said networked ASD, ASD pushed-RFD and RFD for digitally streaming and pushing said processor units-rendered, -selected and -collated ipMAC in and among said processor units-rendered interactive graphics and visual illustrations for networking said processor units, memories and viewing screens and touchscreens according to said processor units-rendered, -selected and -collated ipMAC in and among said protected digital lattices of collations, said streams and pushes for improving and optimizing ASD, ASD pushed-RFD and RFD pushed-RFD users' lives and future and civilizations.

The detailed description and method of ASD, ASD pushed-RFD and RFD pushed-RFD being communication devices—being used by billions of said users—for rendering said protected digital lattices and. SIM in the relational databases in memories and in ASD, ASD pushed-RFD and RFD pushed-RFD processor units-rendered visual displays and illustrations are present in the Claims infra. For example, the following one digital lattice of chain ASD-rendered ipMACn being rendered and pushed by 1 ASD to and among 5 billions ASD pushed-RFD and RFD pushed-RFD exemplified the adaptable SIM-protected digital lattices of collations of chain ipMAC. Said one representative digital lattice of chain ipMAC can be achieved in about 15 minutes or less by and among 5 billions users of ASD, ASD pushed-RFD and RFD pushed-RFD looping ipMACn, where n=1, 2, 3 . . . infinity, beginning, say, at 0100 hour GMT as follow:

At 0100 hour GMT, one digital lattice of chain ASD-rendered ipMAC1

1 cellphone aka ASD authored and sent ASD-rendered ipMACn aka same to 1 Group of 5 cellphones aka ASD pushed-RFD;

5 ASD pushed-RFD forward aka push same to 5 Groups of 25 RFD pushed-RFD;

25 RFD pushed-RFDorward same to 25 Groups of 125 RFD pushed-RFD;

125 RFD pushed-RFD forward same to 125 Groups of 625 RFD pushed-RFD;

625 RFD pushed-RFD forward same to 625 Groups of 3125 RFD pushed-RFD;

3125 RFD pushed-RFD forward same to 3125 Groups of 15625 RFD pushed-RFD;

15625 RFD pushed-RFD forward same to 15625 Groups of 78125 RFD pushed-RFD;

78125 RFD pushed-RFD fo rward same to 78125 Groups of 390625 RFD pushed-RFD;

390625 RFD pushed-RFD forward same to 390625 Groups of 1953125 RFD pushed-RFD;

1953125 RFD pushed-RFD forward same to 1953125 Groups of 9765625 RFD pushed-RFD;

9765625 RFD pushed-RFD forward same to 9765625 Groups of 48828125 RFD pushed-RFD;

48828125 RFD pushed-RFD forward same to 48828125 Groups of 244140625 RFD pushed-RFD;

244140625 RFD pushed-RFD forward same to 1 billion Groups of 5 billions RFD pushed-RFD at 0115 GMT.

In said example of one chain ipMAC1, every IP address of every ASD, ASD pushed-RFD and RFD pushed-RFD is attached to ipMAC1; and in said example of one chain ipMACn, every IP address of every ASD, ASD pushed-RFD and RFD pushed-RFD is attached to ipMACn. Similarly, every ASD, ASD pushed-RFD and RFD pushed-RFD processor units-rendered, -selected and -collated MACn in ipMACn, in and among said protected digital lattices in said relational databases in and among ASD, ASD pushed-RFD and RFD pushed-RFD, where n 2, 3 . . . infinity, every IP address of every ASD, ASD pushed-RFD and RFD pushed-RFD-rendered ipMACn remain attached to MACn in ipMAC. In other words, in the relational databases in memories for storing innovative computer programs of and among ASD ASD pushed-RFD and RFD pushed-RFD, any and all relational data, products and services in rendered MACn and ipMAC in said relational databases.

During said same 0100-0115 GMT, among said same 5 billions ASD, ASD pushed-RFD and RFD pushed-RFD rendering said protected digital lattices and SIM comprise numerous said sample digital lattices of chain ASD-rendered ipMACn. Consequently, some 5 billions rendering a plurality of digital loops of ASD, ASD pushed-RFD and RFD pushed-RFD rendered adaptable SIM-protected digital lattices of collations of chain ipMACn.

In other words, said ASD, ASD pushed-RFD and RFD pushed-RFD for continuously rendering ASD, ASD pushed-RFD and RFD pushed-RFD processor units-rendered, -selected and -collated ipMAC for rendering said adaptable SIM-protected digital lattices of collations of chain ipMAC in plurality of interactive graphics and visual illustrations for tracking and detailing geographic locations, distributions, incidences and prevalences of digital streams and pushes of processor units-rendered, -selected and -collated ipMAC in and among said protected digital lattices, according to said processor units-rendered, -selected and -collated ipMAC, in and among ASD, ASD pushed-RFD and RFD pushed-RFD processor units-rendered interactive visual displays and illustrations comprise said protected digital lattices in and among viewing screens and touchscreens and relational databases of ASD, ASD pushed-RFD and RFD pushed-RFD. ipMAC comprise MAC wherein attached assigned identification codes such as, but not limited to, area codes of ASD, ASD pushed-RFD and RFD pushed-RFD; and ipMAC comprise MAC attached to ASD, ASD pushed-RFD and RFD pushed-RFD Internet Protocol addresses commonly known as IP addresses of ASD, ASD pusheod-RFD and RFD pushed-RFD.

Said primary keys in MAC are:

assigned identification codes of ASD, ASD pushed-RFD and RFD pushed-RFD;

categories of titles of information data and messages;

categories of products;

categories of services;

categories of financial transactions;

titles of information data and messages;

The secondary keys in MAC are:

said information data and messages

said products;

said services;

said financial transactions;

related accounted quantities, incidences and prevalences;

related devices-stamped time;

in said relational databases;

Said primary key in ipMAC is:

IP addresses of ASD, ASD pushed-RFD and RFD attached to said primary keys in MAC in said relational databases.

First, IP addresses are a vital component of SIM comprise ASD, ASD pushed-RFD and RFD pushed-RFD processor units-analyzed and selected bytes of MAC in ipMAC in and among ASD, ASD pushed-RFD and RFD pushed-RFD processor units-rendered ipMAC in said relational databases;

ASD, ASD pushed-RFD and RFD pushed-RFD processor units processor units for analyzing, authencating, and admitting any ASD, ASD pushed-RFD or RFD pushed-RFD processor units-rendered ipMAC—comprise IP addresses—known in the Claims as ANY into said relational databases based on same, similar and relevant MAC, in said ipMAC, to SIM; said processor units for analyzing and blocking ANY into said relational databases based on dissimilar or irrelevant MAC, in said ipMAC, to SIM; thus, SIM for protecting AIR eCommerce from identities thefts, frauds, cyberattacks, hackings and corruptions, of AIR eCommerce.

In other words, ASD, ASD pushed-RFD and RFD pushed-RFD are smartphones, laptops and desktops without servers. The present invention networked ASD, ASD pushed-RFD and RFD pushed-RFD possessing immensely huge ASD, ASD pushed-RFD and RFD pushed-RFD memories and processor units for processing, rendering and supporting and storing data in and among networked ASD, ASD pushed-RFD and RFD pushed-RFD wherein said relational databases can be processed and propagated. Said adaptable SIM-protected digital lattices of collations of chain ipMAC comprise infinite ASD, ASD pushed-RFD and RFD pushed-RFD loopings so much so that ASD, ASD pushed-RFD and RFD pushed-RFD memories share said relational databases, Thus, the status quo commercial servers are moot.

Therefore, further to MAC and ipMAC supra, to achieve the objectives and goals of the present invention, AIR eCommerce applies at least said assigned identification codes such as, but not limited to, area codes—said primary key for activating said innovative computer programs to instruct said ASD, ASD pushed-RFD and RFD pushed-RFD processor units to render, analyze, select and collate ipMAC in and among said protected digital lattices—of ASD, ASD pushed-RFD and RFD pushed-RFD in MAC to render and push said protected digital lattices in said relational databases in said memories and in ASD, ASD pushed-RFD and RFD pushed-RFD processor units-rendered visual displays comprise, but not limited to, said interactive graphics and visual presentations for tracking and detailing geographic locations, distributions, incidences and prevalences of said processor units-rendered, -selected and -collated ipMAC in and among said protected digital lattices in and among ASD, ASD pushed-RFD and RFD pushed-RFD processor units-rendered interactive visual displays and illustrations comprise said protected digital lattices in and among viewing screens and touchscreens of and among said networked ASD, ASD pushed-RFD and RFD pushed-RFD for digitally streaming and pushing said processor units-rendered, -selected and -collated ipMAC.

Second, IP addresses in ASD, ASD pushed-RFD and RFD-rendered ipMAC enable ASD, ASD pushed-RFD and RFD pushed-IUD processor units to precisely and accurately relate ipMAC in and among said protected digital lattices, a consequence of IP addresses being a vital component of SIM, based on IP addresses in ipMAC.

Third, further to supra, said IP addresses—said primary key for enabling said innovative computer programs to instruct said ASD, ASD pushed-RFD and RFD pushed-RFD processor units to render, select and collate ipMAC, in and among said protected digital lattices to render digital streams and pushes of said rendered, selected and collated ipMAC to and in precise and accurate interactive visual displays and illustrations based on ipMAC in said rendered, selected and collated ipMAC. A case in point, further to said Background of the Invention, IP addresses of 5 billions ASD, ASD pushed-RFD and RFD pushed-RFD—of users in any and all industries—in and among said protected digital lattices in ASD, ASD pushed-RFD and RFD pushed-RFD processor units-rendered interactive graphics and visual illustrations for tracking and detailing geographic locations, distributions, incidences and prevalences of said selected and collations of ASD, ASD pushed-RFD and RFD pushed-RFD processor units-rendered, -selected and -collated ipMAC for accurately, precisely and seamlessly streaming and pushing said information, data and messages on people, goods, products and services, financial transactions and related quantities and time-stamps for and among billions of people, households, businesses, enterprises, farmings, localities, communities, cities, states, etc. anywhere on earth. Consequently, the industrial, business and socioeconomic advantages and benefits for billions of users of networked communication devices as described infra are infinitely immense.

AIR eCommerce rendering said abiotic intelligence-rendered processes for rendering said immense protected digital lattices in ASD, ASD pushed-RFD and RFD pushed-RFD processor units-rendered interactive graphics and visual illustrations for rendering and streaming the omnipotent and omnipresent AIR eCommerce of instant and live thus adaptable SIM-protected digital lattices of collations of chain ipMAC in and among ASD, ASD pushed-RFD and RFD pushed-RFD processor units-rendered interactive visual displays and illustrations comprise said protected digital lattices in and among said viewing screens and touchscreens of ASD, ASD pushed-RFD and RFD pushed-RFD processor units-rendered, -selected and -collated ipMAC thus targeted ASD, ASD pushed-RFD and RFD pushed-RFD in and among billions of ASD, ASD pushed-RFD and RFD pushed-RFD.

Said myriad of interactive visual displays and illustrations such as, but not limited to, interactive multi-dimensional digital ledgers and spreadsheets, graphs graphics, graphic images and visual presentations such as, but not limited to, pictures, videoes and real-time multidimensional visual hierarchied degree distribution graphs.

Furthermore, said visual displays and illustrations comprise colored graphics such as, but not limited to, national, regional and local maps. Said interactive multi-dimensional digital ledgers and spreadsheets, graphs graphics, graphic images of financial transactions involve, but not limited to, national currencies and digital currencies including flat currencies and cryptocurrencies of and among ASD, ASD pushed-RFD and RFD pushed-RFD.

It is to be understood that sending and forwarding are synonyms of pushing and streaming, therefore, are interchangeable herein.

ASD, ASD pushed-RFD and RFD pushed-RFD comprise Apple, Samsung, Nokia, Blackberry, Ericcson smartphones and Hewlett Packard, Dell, Lenovo laptops and computers, etc. Moreover, ASD, ASD pushed-RFD and RFD pushed-RFD, as illustrated supra, may or may include or may or may depend on the status quo commercial servers and connectivity.

ASD, ASD pushed-RFD and RFD pushed-RFD use wireless, cable and commercial software technologies and common web browsers of several technology corporations commonly found in smartphones, laptops and desktops.

Although said processor units-rendered interactive visual illustrations of said streams and pushes are such as, but not limited to, interactive multi-dimensional graphs, spreadsheets and network visual-hierarchied data visualizations of visual-hierarchied flowingData—schematically represented in said diagram and described herein—representing one of the preferred embodiments of the present invention, it will be appreciated by and obvious to those skilled in the art and science that a myriad of interactive network visualizations of visual-hierarchied flowingData such as, but not limited to, various interactive spectrums and gradients of connected visual-hierarchied data points, interactive ledgers, graphs and interactive network visualizations of flowingdata of connected visual-hierarchied data points and adaptations, variations and derivatives will be made and used to achieve the objectives of the invention without departing from the spirit and scope of the specification of the present invention.

Although various preferred embodiments of the present invention have been described, it will be appreciated by and obvious to those skilled in the art and science that adaptations, variations and derivatives of said embodiments are and will be made and achieved for people, animals and machines and objects without departing from the spirit and scope of the specification of the present invention.

1. AIR eCommerce comprise ASD, ASD pushed-RFD and RFD pushed-RFD for freely and independently rendering and pushing ASD, ASD pushed-RFD and RFD pushed-RFD processor units-rendered, -selected and -collated ipMAC for abiotic intelligence-rendering said adaptable SIM-protected digital lattices of collations of chain ipMAC in the relational databases in memories henceforth collectively known as protected digital lattices in and among ASD, ASD pushed-RFD and RFD pushed-RFD processor units-rendered myriad of interactive abiotic intelligence-rendered visual displays and illustrations for precisely and accurately tracking and detailing geographic locations, distributions, incidences and prevalences of digital streams and pushes of ASD, ASD pushed-RFD and RFD pushed-RFD processor units-rendered, -selected and -collated ipMAC in and among said protected digital lattices, according to said processor units-rendered, -selected and -collated ipMAC, in and among viewing screens and touchscreens of ASD, ASD pushed-RFD and. RFD pushed-RFD, AIR eCommerce comprise:
ASD, ASD pushed-RFD and RFD pushed-RFD which are smartphones, laptops and desktops comprise said memories for storing said relational databases and innovative computer programs, said memories for attaching to said processor units for using wireless, cable and commercial software technologies for rendering, exchanging, pushing and streaming processor units-rendered, -selected and -collated ipMAC in and among said processor units-rendered ASD, ASD pushed-RFD and RFD pushed-RFD processor units-rendered interactive visual displays and illustrations in and among viewing screens and touchscreens;
ASD, ASD pushed-RFD and RFD pushed-RFD processor units-rendered, -selected and -collated ipMAC for networking said smartphones, laptops and desktops according to said processor units-rendered, -selected and -collated ipMAC;
security ipMAC bytes for protecting AIR eCommerce and said financial transactions in AIR eCommerce henceforth known as SIM; and
said innovative computer programs for instructing said processor units for rendering ASD, ASD pushed-RFD and RFD, said processor units-rendered, -selected and -collated ipMAC in said protected digital lattices, SIM for protecting AIR eCommerce, digital streams and pushes related to ipMAC in and among said protected digital lattices in and among said myriad.

2. The AIR eCommerce according to claim 1 wherein ipMAC comprise primary keys in said relational databases wherein said primary keys in MAC are:
assigned identification codes of ASD, ASD pushed-RFD and RFD pushed-RFD;
categories of titles of information data and messages;
categories of products;
categories of services;
categories of financial transactions;
titles of information data and messages; and
SIM;
MAC comprise secondary keys which are;
said information data and messages
said products;
said services;
said financial transactions;
related accounted quantities, incidences and prevalences;
related devices-stamped time; and
in said relational databases.

3. The AIR eCommerce according to claim 1 wherein ipMAC comprise primary keys in said relational databases wherein said primary keys in ipMAC are:
IP addresses of ASD, ASD pushed-RFD and RFD; and
IP addresses related to said primary keys in MAC in said relational databases;

4. The primary keys according to claim 2 comprise:
ASD, ASD pushed-RFD and RFD pushed-RFD processor units-rendered, -selected and -collated primary keys in and among ASD, ASD pushed-RFD and RFD pushed-RFD processor units-rendered, -selected and -collated ipMAC in said protected digital lattices;
ASD, ASD pushed-RFD and RFD pushed-RFD processor units-rendered, -selected and -collated primary keys for activating said innovative computer programs for instructing said ASD, ASD pushed-RFD and RFD pushed-RFD processor units for rendering processor units-rendered, -selected and -collated ipMAC based on said primary keys for streaming and pushing ASD, ASD pushed-RFD and RFD pushed-RFD processor units-rendered, -selected and -collated ipMAC in and among said interactive visual displays and illustrations, according to said ASD, ASD pushed-RFD and RFD pushed-RFD processor units-rendered, -selected and -collated primary keys;
said interactive visual displays and illustrations for tracking and detailing geographic locations, distributions, incidences and prevalences of said selected and collations of ASD, ASD pushed-RFD and RFD pushed-RFD processor units-rendered, -selected and -collated ipMAC in said protected digital lattices, according to said ASD, ASD pushed-RFD and RFD pushed-RFD processor units-rendered, -selected and -collated primary keys.

5. The AIR eCommerce according to claim 1 wherein ASD, ASD pushed-RFD and RFD pushed-RFD are:
ASD comprise individual networked authors-senders devices for authoring and storing ASI) processor units-rendered MAC to which attached said assigned identification codes of ASD collectively known as ASD-rendered MAC to which attached IP addresses of ASD collectively known as ASD-rendered ipMAC in said relational databases in said memories in and among ASD;
ASD for selecting Groups of networked receivers-forwards communication devices, according to ASD processor units-analyzed, selected and collated MAC and ipMAC in and among processor units-rendered adaptable and innately protected digital lattices of chain MAC and ipMAC in said relational databases, collectively known herein as said ASD pushed-RFD;
ASD for sending ASD-rendered ipMAC to said ASD pushed-RFD;
ASD pushed-RFD for receiving ASD-rendered MAC and ipMAC;
ASD pushed-RFD for selecting a plurality of Groups of networked receivers-forwards communication devices, according to ASD pushed-RFD processor units-analyzed, selected and collated MAC and ipMAC in and among processor units-rendered adaptable and innately protected digital lattices of chain MAC and ipMAC in said relational databases, collectively known herein as said RFD-pushed RFD;
ASD pushed-RFD forwarding ASD-rendered MAC and ipMAC to which attached IP addresses of said RFD-pushed RFD to RFD-pushed RFD;
RFD pushed-RFD for receiving ASD-rendered MAC and ipMAC to which attached IP addresses of RFD-pushed RFD;
RFD pushed-RFD for selecting a plurality of Groups of networked receivers-forwards communication devices, according to RFD-pushed RFD processor units-analyzed, selected and collated MAC and ipMAC in and among processor units-rendered adaptable and innately protected digital lattices of chain MAC and ipMAC in said relational databases, collectively known as a plurality of RFD-pushed RFD for rendering and expandin said processor units-rendered adaptable and innately protected digital lattices of chain MAC and ipMAC in said relational databases;
said plurality of RFD-pushed RFD for selecting a plurality of Groups of networked receivers-forwards communication devices, according to ASD pushed-RFD processor units-analyzed, selected and collated MAC and ipMAC in and among processor units-rendered adaptable and innately protected digital lattices of chain MAC and ipMAC in said relational databases, collectively known as plurality RFD-pushed RFD for rendering and expandin said processor units-rendered adaptable and innately protected digital lattices of chain MAC and ipMAC in said relational databases;
RFD pushed-RFD forwarding ASD-rendered MAC and ipMAC to which attached IP addresses of RFD-pushed RFD to said plurality RFD-pushed RFD;
said plurality RFD pushed-RFD for receiving ASD-rendered MAC and ipMAC to which attached IP addresses of said plurality RFD-pushed RFD for rendering and expandin said processor units-rendered adaptable and innately protected digital lattices of chain MAC and ipMAC in said relational databases; and
ASD, ASD pushed-RFD and RFD pushed-RFD processor units-rendered adaptable and innately protected digital lattices of chain ipMAC for networking said ASD, ASD pushed-RFD and RFD pushed-RFD being said networked smartphones, laptops and desktops in said relational databases in said memories.

6. The AIR eCommerce according to claim 1 wherein SIM comprise said processor units-analyzed and selected bytes of MAC in ipMAC in and among ASD, ASD pushed-RFD and RFD pushed-RFD processor units-rendered ipMAC in said relational databases;
said processor units for analyzing, authencating, and admitting any ASD, ASD pushed-RFD or RFD pushed-RFD processor units-rendered ipMAC henceforth known as ANY into said relational databases based on same, similar and relevant MAC, in said ipMAC, to SIM;
said processor units for analyzing and blocking ANY into said relational databases based on dissimilar or irrelevant MAC, in said ipMAC, to SIM;
thus, SIM for protecting AIR eCommerce from identities thefts, frauds, cyberattacks, hackings and corruptions, of AIR eCommerce.

7. The AIR eCommerce according to claim 1 wherein said protected digital lattices comprise:
ASD processor units-analyzed, selected and collated MAC and ipMAC in and among said protected digital lattices of chain MAC and ipMAC;
ASD pushed-RFD processor units-analyzed, selected and collated MAC and ipMAC in and among said protected digital lattices of chain MAC and ipMAC;
ASD pushed-RFD processor units-analyzed, selected and collated MAC and ipMAC in and among said protected digital lattices of chain MAC and ipMAC;
RFD pushed-RFD processor units-analyzed, selected and collated MAC and ipMAC in and among said protected digital lattices of chain MAC and ipMAC;
a plurality RFD pushed-RFD processor units-analyzed, selected and collated MAC and ipMAC in and among said protected digital lattices of chain MAC and ipMAC; and
said digital streams and pushes related to ipMAC in said relational databases and in and among said protected digital lattices in a myriad of interactive live and real-time ledgers, graphs, multi-dimensional visual hierarchied degree distribution graphs, networked visualizations of visual-hierarchied flowingData, graphics, pictures, videoes in and among said viewing screens and touchscreens.

8. The AIR eCommerce according to claim 1 wherein said digital streamings and pushes comprise ASD, ASD pushed-RFD and RFD pushed-RFD processor units-analyzed, selected and collated chain ipMAC based on same, similar and relevant bytes in MAC henceforth known as pointed and highlighted bytes in ipMAC in and among said ASD, ASD pushed-RFD and RFD pushed-RFD processor units-analyzed, selected and collated chain ipMAC in said relational databases;
processor units for searching any ASD, ASD pushed-RFD and RFD pushed-RFD processor units-rendered ipMAC known herein as ANY in said relational databases;
processor units for relating said pointed and highlighted bytes with same, similar and relevant bytes in ANY;
processor units for relating said pointed and highlighted bytes in ipMAC with ANY in said relational databases;
said processor units for relating ipMAC related to said pointed and highlighted bytes in with ANY in said relational databases;
said processor units for streaming and pushing said relations in and among ASD, ASD pushed-RFD and RFD pushed-RFD processor units-rendered interactive visual displays and illustrations comprise said protected digital lattices in and among viewing screens and touchscreens associated with ANY;
thus, said processor units for rendering said processor units-rendered adaptable and innately protected digital lattices of chain ipMAC; and
said digital streams and pushes related to ipMAC in said relational databases and in and among said protected digital lattices in a myriad of interactive live and real-time ledgers, graphs, multi-dimensional visual hierarchied degree distribution graphs, networked visualizations of visual-hierarchied flowingData, graphics, pictures, videoes in and among said viewing screens and touchscreens.

9. The AIR eCommerce comprise ASD, ASD pushed-RFD and RFD pushed-RFD for rendering interactive graphics and visual mathematical illustrations for tracking and detailing geographic locations, distributions, incidences and prevalences of said processor units-rendered, -selected and -collated ipMAC in digital streams and pushes of ASD, ASD pushed-RFD and RFD pushed-RFD processor units-rendered, -selected and -collated ipMAC in said protected digital lattices in and among ASD, ASD pushed-RFD and RFD pushed-RFD processor units-rendered interactive visual displays and illustrations comprise said protected digital lattices in and among viewing screens and touchscreens associated with ASD, ASD pushed-RFD and RFD processor units attached to memories for storing said relational databases, according to said processor units-rendered, -selected and -collated ipMAC in and among said protected digital lattices of collations, said interactive graphics and visual illustrations for improving and optimizing ASD, ASD pushed-RFD and RFD pushed-RFD users' lives and future and civilization, AIR eCommerce comprise:
networked smartphones, laptops and desktops comprise said memories for storing said relational databases, said protected digital lattices of collations and innovative computer programs, said memories for attaching to said processor units for using wireless, cable and commercial software technologies for rendering, exchanging, pushing and streaming MAC in ipMAC protected digital lattices of collations in and among said processor units-rendered ASD, ASD pushed-RFD and RFD pushed-RFD processor units-rendered interactive visual displays and illustrations comprise said protected digital lattices in and among viewing screens and touchscreens;
ASD, ASD pushed-RFD and RFD pushed-RFD processor units-rendered said protected digital lattices for networking said networked smartphones, laptops and desktops comprise said ASD, ASD pushed-RFD and RFD pushed-RFD processor units for rendering, analyzing and collating said protected digital lattices;
security ipMAC bytes for protecting AIR eCommerce and said financial transactions in AIR eCommerce henceforth known as SIM; and
said innovative computer programs for instructing said processor units for rendering ASD, ASD pushed-RFD and RFD, said innovative computer programs for instructing said processor units for rendering said protected digital lattices of collations wherein said innovative computer programs for instructing said processor units for selecting and collating ipMAC for networking said processor units, memories and viewing screens and touchscreens of and among said networked communication devices, rendering SIM, said innovative computer programs for instructing said processor units for using SIM for protecting AIR eCommerce, said innovative computer programs for instructing said processor units for rendering said interactive graphics and visual mathematical illustrations of said streams and pushes.

10. The AIR eCommerce according to claim 9 wherein MAC comprise primary keys in said relational databases wherein said primary keys in MAC are:
assigned identification codes of ASD, ASD pushed-RFD and RFD pushed-RFD;
categories of titles of information data and messages;
categories of products;
categories of services;
categories of financial transactions;
titles of information data and messages; and
SIM;
MAC comprise secondary keys which are;
said information data and messages
said products;
said services;
said financial transactions;
related accounted quantities, incidences and prevalences;
related devices-stamped time; and
in said relational databases.

11. The AIR eCommerce according to claim 9 wherein ASD, ASD pushed-RFD and RFD pushed-RFD are:
ASD comprise individual networked authors-senders devices for authoring and storing ASD processor units-rendered MAC to which attached said assigned identification codes of ASD collectively known as ASD-rendered MAC to which attached IP addresses of ASD collectively known as ASD-rendered ipMAC in said relational databases in said memories in and among ASD;
ASD for selecting Groups of networked receivers-forwards communication devices, according to ASD processor units-analyzed, selected and collated MAC and ipMAC in and among processor units-rendered adaptable and innately protected digital lattices of chain MAC and ipMAC in said relational databases, collectively known herein as said ASD pushed-RFD;
ASD for sending ASD-rendered ipMAC to said ASD pushed-RFD;
ASD pushed-RFD for receiving ASD-rendered MAC and ipMAC;
ASD pushed-RFD for selecting a plurality of Groups of networked receivers-forwards communication devices, according to ASD pushed-RFD processor units-analyzed, selected and collated MAC and ipMAC in and among processor units-rendered adaptable and innately protected digital lattices of chain MAC and ipMAC in said relational databases, collectively known herein as said RFD-pushed RFD;
ASD pushed-RFD forwarding ASD-rendered MAC and ipMAC to which attached IP addresses of said RFD-pushed RFD to RFD-pushed RFD;
RFD pushed-RFD for receiving ASD-rendered MAC and ipMAC to which attached IP addresses of RFD pushed-RFD;
RFD pushed-RFD for selecting a plurality of Groups of networked receivers-forwards communication devices, according to RFD-pushed RFD processor units-analyzed, selected and collated MAC and ipMAC in and among processor units-rendered adaptable and innately protected digital lattices of chain MAC and ipMAC in said relational databases, collectively known as a plurality of RFD-pushed RFD for rendering and expandin said processor units-rendered adaptable and innately protected digital lattices of chain MAC and ipMAC in said relational databases;
said plurality of RFD-pushed RFD for selecting a plurality of Groups of networked receivers-forwards communication devices, according to ASD pushed-RFD processor units-analyzed, selected and collated MAC and ipMAC in and among processor units-rendered adaptable and innately protected digital lattices of chain MAC and ipMAC in said relational databases, collectively known as plurality RFD-pushed RFD for rendering and expandin said processor units-rendered adaptable and innately protected digital lattices of chain MAC and ipMAC in said relational databases;
RFD pushed-RFD forwarding ASD-rendered MAC and ipMAC to which attached IP addresses of RFD pushed-RFD to said plurality RFD-pushed RFD;
said plurality RFD pushed-RFD for receiving ASD-rendered MAC and ipMAC to which attached IP addresses of said plurality RFD-pushed RFD for rendering and expandin said processor units-rendered adaptable and innately protected digital lattices of chain MAC and ipMAC in said relational databases; and
ASD, ASD pushed-RFD and RFD pushed-RFD processor units-rendered adaptable and innately protected digital lattices of chain ipMAC for networking said ASD, ASD pushed-RFD and RFD pushed-RFD being said networked smartphones, laptops and desktops in said relational databases in said memories.

12. The AIR eCommerce according to claim 9 wherein SIM comprise said processor units-analyzed and selected bytes of MAC in ipMAC in and among ASD, ASD pushed-RFD and RFD pushed-RFD processor units-rendered ipMAC in said relational databases;
said processor units for analyzing, authencating, and admitting any ASD, ASD pushed-RFD or RFD pushed-RFD processor units-rendered ipMAC henceforth known as ANY into said relational databases based on same, similar and relevant MAC, in said ipMAC, to SIM;
said processor units for analyzing and blocking ANY into said relational databases based on dissimilar or irrelevant MAC, in said ipMAC, to SIM; thus,
SIM for protecting AIR eCommerce from identities thefts, frauds, cyberattacks, hackings and corruptions, of AIR eCommerce.

13. The AIR eCommerce according to claim 9 wherein said protected digital lattices comprise:
ASD processor units-analyzed, selected and collated MAC and ipMAC in and among processor units-rendered said protected digital lattices;
ASD pushed-RFD processor units-analyzed, selected and collated MAC and ipMAC in and among processor units-rendered said protected digital lattices;
ASD pushed-RFD processor units-analyzed, selected and collated MAC and ipMAC in and among processor units-rendered said protected digital lattices;
RFD pushed-RFD processor units-analyzed, selected and collated MAC and ipMAC in and among processor units-rendered said protected digital lattices;
a plurality RFD pushed-RFD processor units-analyzed, selected and collated MAC and ipMAC in and among processor units-rendered said protected digital lattices; and
said digital streams and pushes related to ipMAC in said relational databases and in and among said protected digital lattices in a myriad of interactive live and real-time ledgers, graphs, multi-dimensional visual hierarchied degree distribution graphs, networked visualizations of visual-hierarchied flowingData, graphics, pictures, videoes in and among said viewing screens and touchscreens.

14. In AIR eCommerce comprise ASD, ASD pushed-RFD and RFD pushed-RFD for rendering interactive graphics and visual mathematical illustrations for tracking and detailing geographic locations, distributions, incidences and prevalences of said processor units-rendered, -selected and -collated ipMAC in digital streams and pushes of ASD, ASD pushed-RFD and RFD pushed-RFD processor units-rendered, -selected and -collated ipMAC in said protected digital lattices in and among ASD, ASD pushed-RFD and RFD pushed-RFD processor units-rendered interactive visual displays and illustrations comprise said protected digital lattices in and among viewing screens and touchscreens, according to said processor units-rendered, -selected and -collated ipMAC, a method of ASD, ASD pushed-RFD and RFD pushed-RFD rendering interactive graphics and visual illustrations for tracking and detailing geographic locations, distributions, incidences and prevalences of selected and collations of ASD, ASD pushed-RFD and RFD pushed-RFD-rendered, -selected and -collated ipMAC being pushed by and among ASD, ASD pushed-RFD and RFD pushed-RFD, said method comprises processes of:
ASD, ASD pushed-RFD and RFD pushed-RFD rendering and pushing chain ipMAC to ASD, ASD pushed-RFD and RFD pushed-RFD to render said protected digital lattices networking ASD, ASD pushed-RFD and RFD pushed-RFD in said relational databases from where said networked ASD, ASD pushed-RFD and RFD digitally streaming and pushing said processor units-rendered, -selected and -collated ipMAC in and among said interactive graphics and visual mathematical illustrations tracking and detailing geographic locations, distributions, incidences and prevalences of said processor units-rendered, -selected and -collated ipMAC in and among said protected digital lattices, said streams and pushes, according to said processor units-rendered, -selected and -collated ipMAC in and among said protected digital lattices of collations;
rendering said ASD, ASD pushed-RFD and RFD pushed-RFD to rendering and managing said ASD, ASD pushed-RFD and RFD pushed-RFD processor units-rendered protected digital lattices of chain ipMAC in said relational databases and in and among ASD, ASD pushed-RFD and RFD pushed-RFD processor units-rendered interactive visual displays and illustrations comprise said protected digital lattices in and among viewing screens and touchscreens;
said ASD, ASD pushed-RFD and RFD pushed-RFD processor units-rendered protected digital lattices of chain ipMAC to networking said networked smartphones, laptops and desktops comprise ASD, ASD pushed-RFD and RFD pushed-RFD based on said ASD, ASD pushed-RFD and RFD pushed-RFD processor units-analyzed, selected and collated chain information and data related to users of said networked communication devices and products and services and including financial transactions related time and quantities attached said assigned identification codes of said networked communication devices; rendering SIM;
rendering digital streamings and pushes to rendering and managing said ASD, ASD pushed-RFD and RFD pushed-RFD processor units-rendered said protected digital lattices of chain ipMAC in said relational databases and in and among ASD, ASD pushed-RFD and RFD pushed-RFD processor units-rendered interactive visual displays and illustrations comprise said protected digital lattices in and among viewing screens and touchscreens; and
said innovative computer programs instructing said processor units to rendering ASD, ASD pushed-RFD and RFD, said innovative computer programs to instructing said processor units to rendering said protected digital lattices wherein said innovative computer programs instructing said processor units to selecting and collating ipMAC to networking said processor units, memories and viewing screens and touchscreens of and among ASD, ASD pushed-RFD and RFD pushed-RFD, said innovative computer programs for instructing ASD, ASD pushed-RFD and RFD pushed-RFD processor units to rendering SIM to protecting AIR eCommerce, said innovative computer programs instructing said processor units using SIM to protecting AIR eCommerce, said innovative computer programs instructing said processor units to rendering said interactive graphics and visual illustrations of said streams and pushes.

15. The method according to claim 14 wherein said process of ASD, ASD pushed-RFD and RFD pushed-RFD rendering said interactive graphics and visual illustrations for tracking and detailing geographic locations, distributions, incidences and prevalences of selected and collations of ASD, ASD pushed-RFD and RFD pushed-RFD processor units-rendered, -selected and -collated ipMAC in said protected digital lattices, said method comprises processes of said innovative computer programs instructing ASD, ASD pushed-RFD and RFD pushed-RFD processor units to render primary keys in said relational databases wherein said primary keys in MAC are:
assigned identification codes of ASD, ASD pushed-RFD and RFD pushed-RFD;
categories of titles of information data and messages;
categories of products;
categories of services;
categories of financial transactions;
titles of information data and messages; and
SIM;
render MAC comprise secondary keys which are;
said information data and messages
said products;
said services;
said financial transactions;
related accounted quantities, incidences and prevalences;
related devices-stamped time;
in said relational databases; and
render ipMAC to comprise:
IP addresses of ASD, ASD pushed-RFD and RFD; and
IP addresses related to said primary keys in MAC in said relational databases;

16. The method according to claim 14 wherein said process of ASD, ASD pushed-RFD and RFD pushed-RFD rendering and pushing chain ipMAC to ASD, ASD pushed-RFD and RFD pushed-RFD to render said protected digital lattices, said process comprise ASD authoring and storing ASD processor units-rendered MAC to which attached said assigned identification codes of ASD collectively known as ASD-rendered MAC to which attached IP addresses of ASD collectively known as ASD-rendered ipMAC in said relational databases in said memories in and among ASD;
ASD selecting Groups of networked receivers-forwards communication devices, according to ASD processor units-analyzed, selected and collated MAC and ipMAC in and among processor units-rendered adaptable and innately protected digital lattices of chain MAC and ipMAC in said relational databases, collectively known herein as said ASD pushed-RFD;
ASD sending ASD-rendered ipMAC to said ASD pushed-RFD;
ASD pushed-RFD receiving ASD-rendered MAC and ipMAC;
ASD pushed-RFD selecting a plurality of Groups of networked receivers-forwards communication devices, according to ASD pushed-RFD processor units-analyzed, selected and collated MAC and ipMAC in and among processor units-rendered adaptable and innately protected digital lattices of chain MAC and ipMAC in said relational databases, collectively known herein as said RFD-pushed RFD;
ASD pushed-RFD forwarding ASD-rendered MAC and ipMAC to which attached IP addresses of said RFD-pushed RFD to RFD-pushed RFD;
RFD pushed-RFD receiving ASD-rendered MAC and ipMAC to which attached IP addresses of RFD pushed-RFD;
RFD pushed-RFD selecting a plurality of Groups of networked receivers-forwards communication devices, according to RFD-pushed RFD processor units-analyzed, selected and collated MAC and ipMAC in and among processor units-rendered adaptable and innately protected digital lattices of chain MAC and ipMAC in said relational databases, collectively known as a plurality of RFD-pushed RFD rendering and expandin said processor units-rendered adaptable and innately protected digital lattices of chain MAC and ipMAC in said relational databases;
said plurality of RFD-pushed RFD selecting a plurality of Groups of networked receivers-forwards communication devices, according to ASD pushed-RFD processor units-analyzed, selected and collated MAC and ipMAC in and among processor units-rendered adaptable and innately protected digital lattices of chain MAC and ipMAC in said relational databases, collectively known as plurality RFD-pushed RFD rendering and expandin said processor units-rendered adaptable and innately protected digital lattices of chain MAC and ipMAC in said relational databases;
RFD pushed-RFD forwarding ASD-rendered MAC and ipMAC to which attached IP addresses of RFD pushed-RFD to said plurality RFD-pushed RFD;
said plurality RFD pushed-RFD receiving ASD-rendered MAC and ipMAC to which attached IP addresses of said plurality RFD-pushed. RFD rendering and expandin said processor units-rendered adaptable and innately protected digital lattices of chain MAC and ipMAC in said relational databases; and
ASD, ASD pushed-RFD and RFD pushed-RFD processor units-rendered adaptable and innately protected digital lattices of chain ipMAC networking said ASD, ASD pushed-RFD and RFD pushed-RFD being said networked smartphones, laptops and desktops in said relational databases in said memories.

17. The AIR eCommerce according to claim 14 wherein said process of rendering SIM comprise said processor units analyzing and selecting bytes of MAC in ipMAC in and among ASD, ASD pushed-RFD and RFD pushed-RFD processor units-rendered ipMAC in said relational databases;
said processor units analyzing, authencating, and admitting any ASD, ASD pushed-RFD or RFD pushed-RFD processor units-rendered ipMAC henceforth known as ANY into said relational databases based on same, similar and relevant MAC, in said ipMAC, to SIM;
said processor units analyzing and blocking ANY into said relational databases based on dissimilar or irrelevant MAC, in said ipMAC, to SIM; thus,
SIM protecting AIR eCommerce from identities thefts, frauds, cyberattacks, hackings and corruptions, of AIR eCommerce.

18. The method according to claim 14 wherein ASD, ASD pushed-RFD and RFD pushed-RFD comprise said processor units attached to said memories for storing said relational databases and innovative computer programs, said innovative computer programs instructing said processor units to render:
ASD, ASD pushed-RFD and RFD pushed-RFD processor units-rendered said protected digital lattices of chain ipMAC to network said ASD, ASD pushed-RFD and RFD pushed-RFD being said networked smartphones, laptops and desktops in said relational databases;
ASD authoring and storing ASD processor units-rendered MAC to which ASD attached said assigned identification codes of ASI) collectively known as ASD-rendered MAC to which ASD attached IP addresses of ASD collectively known as ASD-rendered ipMAC in said relational databases;
ASD selecting Groups of networked receivers-forwards communication devices, according to ASD processor units-analyzed, selected and collated MAC and ipMAC in and among said processor units-rendered adaptable and innately protected digital lattices of chain MAC and ipMAC in said relational databases, said selected Groups of networked receivers-forwards communication devices collectively known as ASD pushed-RFD in said relational databases;
ASD relating ASD-rendered ipMAC to ASD pushed-RFD in said relational databases;
ASD pushed-RFD related to ASD-rendered MAC and ipMAC in said relational databases;
ASD pushed-RFD selecting a plurality of Groups of networked receivers-forwards communication devices, according to ASD pushed-RFD processor units-analyzed, selected and collated MAC and ipMAC in and among processor units-rendered adaptable and innately protected digital lattices of chain MAC and ipMAC in said relational databases, collectively known as RFD-pushed RFD;
ASD pushed-RFD forwarding ASD-rendered MAC and ipMAC to which attached IP addresses of RFD-pushed RFD to RFD-pushed RFD in said relational databases;
RFD pushed-RFD receiving ASD-rendered MAC and ipMAC to which attached IP addresses of RFD-pushed RFD in said relational databases;
RFD pushed-RFD selecting a plurality of Groups of networked receivers-forwards communication devices, according to RFD-pushed RFD processor units-analyzed, selected and collated MAC and ipMAC in and among processor units-rendered adaptable and innately protected digital lattices of chain MAC and ipMAC in said relational databases, collectively known as a plurality of RFD-pushed RFD rendering and expandin said processor units-rendered adaptable and innately protected digital lattices of chain MAC and ipMAC in said relational databases;
said plurality of RFD-pushed RFD selecting a plurality of Groups of networked receivers-forwards communication devices, according to ASD pushed-RFD processor units-analyzed, selected and collated MAC and ipMAC in and among processor units-rendered adaptable and innately protected digital lattices of chain MAC and ipMAC in said relational databases, collectively known as plurality RFD-pushed RFD rendering and expandin said processor units-rendered adaptable and innately protected digital lattices of chain MAC and ipMAC in said relational databases;
RFD pushed-RFD forwarding ASD-rendered MAC and ipMAC to which attached IP addresses of RFD-pushed RFD to said plurality RFD-pushed RFD in said relational databases;
said plurality RFD pushed-RFD receiving ASD-rendered MAC and ipMAC to which attached IP addresses of said plurality RFD-pushed RFD rendering and expandin said processor units-rendered adaptable and innately protected digital lattices of chain MAC and ipMAC in said relational databases;
ASD, ASD pushed-RFD and RFD pushed-RFD processor units-rendered protected digital lattices of chain ipMAC networking said networked smartphones, laptops and desktops comprise said ASD, ASD pushed-RFD and RFD pushed-RFD based on said ASD, ASD pushed-RFD and RFD pushed-RFD processor units-analyzed, selected and collated chain information and data related to users of said networked communication devices and products and services and including financial transactions related time and quantities attached said assigned identification codes of said networked communication devices in said relational databases;
ASD, ASD pushed-RFD and RFD pushed-RFD processor units rendering SIM; and
said digital streams and pushes related to ipMAC in said relational databases and in and among said protected digital lattices in a myriad of interactive live and real-time ledgers, graphs, multi-dimensional visual hierarchied degree distribution graphs, networked visualizations of visual-hierarchied flowingData, graphics, pictures, videoes in and among said viewing screens and touchscreens.

19. The method according to claim 14 wherein said process of ASD, ASD pushed-RFD and RFD pushed-RFD processor units rendering SIM comprises processes of:
ASD, ASD pushed-RFD and RFD pushed-RFD processor units analyzing and selecting bytes of MAC in ipMAC in and among ASD, ASD pushed-RFD and RFD pushed-RFD processor units-rendered ipMAC in said relational databases;
said processor units analyzing, authencating, and admitting any ASD, ASD pushed-RFD or RFD pushed-RFD processor units-rendered ipMAC henceforth known as ANY into said relational databases based on same, similar and relevant MAC, in said ipMAC, to SIM;
said processor units analyzing and blocking ANY into said relational databases based on dissimilar or irrelevant MAC, in said ipMAC, to SIM; thence
SIM protecting AIR eCommerce from identities thefts, frauds, cyberattacks, hackings and corruptions, of AIR eCommerce,
